(19) United States
(12) Patent Application Publication
(10) Pub. No.: US 2026/0365174 A1
(43) Pub. Date: Nov. 19, 2026

(54) MOTION PLANNING IN MOBILE ROBOTS

(71) Applicant: Five AI Limited, Cambridge (GB)

(72) Inventors: Bence Magyar, Cambridge (GB); Sean Mullan, Cambridge (GB); Alexandre Silva, Cambridge (GB); Hugo Sardinha, Cambridge (GB); Alejandro Bordallo, Cambridge (GB); Ludovico Carozza, Cambridge (GB)

(73) Assignee: Five AI Limited, Cambridge (GB)

(21) Appl. No.: 19/488,422

(22) PCT Filed: May 31, 2024
(86) PCT No.: PCT/EP2024/065022

§ 371 Date: Nov. 26, 2025

(30) Foreign Application Priority Data
Jun. 2, 2023 (GB) 2308283.7

(51) Int. Cl. B60W 30/18; B60W 50/00; B60W 60/00

(52) U.S. Cl. CPC B60W 30/18163; B60W 50/0098; B60W 60/0013; B60W 60/0015; B60W 2552/20; B60W 2554/4041

(57) ABSTRACT

Computer systems and methods for planning a spatial path and a motion profile for an ego agent. The system comprises: an input configured to receive a state of the ego agent, and a trajectory generator configured to determine, based on the state of the ego agent, a first trajectory via a constrained optimization of a cost function encoding one or more soft planning constraints, subject to one or more hard planning constraints; the first trajectory comprising a spatial path and a motion component, the spatial path determined via the constrained optimization in dependence on at least one of a hard planning constraint and a soft planning constraint on the motion component; a motion planner configured to compute, based on the spatial path of the first trajectory, a motion profile for the ego agent satisfying one or more constraints of the motion planner.

### TECHNICAL FIELD

The present invention relates to motion planning in mobile robots. Particularly, but not exclusively, the present invention is directed to motion planning in autonomous vehicles.

### BACKGROUND

A rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

Motion planners for autonomous vehicles can be configured to implement a number of behaviours that comply with safety requirements, such as adaptive cruise control (ACC), to control the speed of the vehicle based on other agents on the same path.

One approach to planning for autonomous vehicles in order to satisfy requirements on safety, progress and/or comfort is to formulate planning as a constrained optimisation problem. One possible planning architecture is to implement a non-linear programming (NLP) based planner to generate a trajectory based on a set of inputs defining the ego agent's state and that of other agents present, while satisfying kinematic and dynamic constraints as well as avoiding collision with other agents. This may be implemented as a second stage of a two-stage optimisation architecture, where the first stage uses a planner to solve a simplified version of the planning problem, to generate an initial trajectory which is used to initialise the second NLP planner, which solves the full planning problem. Such an architecture is disclosed in International Patent Publication Nos. WO2021152050 and WO2021152047, which are herein incorporated by reference in their entirety.

### SUMMARY

When planning for autonomous vehicle (AV) or other mobile robot, one approach is to follow a default path in most situations, and only deviate from this default behaviour as necessary. The default path could be, for example, the centre line of a driving lane in which the AV is travelling. Deviation from a default path could be engaged, for example, where the relative position and speeds of the AV and an agent in front of the ego vehicle in the same lane (also referred to as a forward vehicle) are such that an overtake maneuver is desired. In this case, planning of the overtake maneuver needs to be handled by a real-time planner that can generate a suitable trajectory for the AV.

Planning can be formulated as a constrained optimization problem, where trajectories, comprising a spatial path and a corresponding motion component for the vehicle along that path, can be generated that satisfy a range of constraints on safety, comfort, and progress, providing a smooth and safe trajectory for an ego vehicle. The spatial path defines a sequence of locations and orientations of the ego vehicle within a road layout over a specified future time interval, while the motion component defines corresponding motion variables such as acceleration or velocity over the same time interval. Both the spatial path and motion component are determined in dependence on hard and/or soft constraints on the motion of the vehicle, such that the overall trajectory complies with those motion constraints. However, a possible drawback of optimization-based planning techniques, in particular, optimisation-based ‘free space’ planners, where a planned trajectory is generated within an open region of space, as opposed to being limited to following a particular path or one of a set of paths, is that they cannot always be used to generate a planned trajectory satisfying all the constraints of the planning problem within some specified time limit for planning. A typical time limit that may be specified for AV planning is 100 ms, though this can be adjusted according to the given circumstances. This may be referred to herein as planning in real time or near real time.

Alternatively, motion planners can be applied directly to a given input spatial path (referred to as a ‘driveable’ path) to generate a motion profile for that spatial path that satisfies predefined vehicle behaviours. The motion planner may be referred to herein as a ‘classical’ or ‘physics-based’ planner, since it plans the vehicle motion such that it satisfies predefined physical rules. For example, a motion planner can implement a ‘lane following’ behaviour, wherein by default it follows the provided driveable path at a nominal speed, but switches to other behaviours, such as overtake, if certain conditions are met. This planner can be implemented in real time to generate suitable motion profiles.

A method described herein is provided that combines optimisation-based planning and rule-based motion profile generation in order to provide real-time motion planning while also providing guarantees on the safety and smoothness of the path followed by a vehicle.

According to the methods described herein, a path and motion component are generated for an ego vehicle by a constrained optimisation based planner, such that both the spatial path and motion component of the resultant trajectory satisfy constraints on the ego vehicle's motion (including, for example, constraints on collision avoidance, kinematic constraints and upper limits on acceleration and steering angle, among other constraints). Thus, not only the planned motion of the vehicle, but also the spatial path itself satisfy motion constraints on the vehicle. The spatial path generated by the constrained optimisation based planner is then used as a basis for an input ‘driveable’ path for a motion planner to determine a suitable motion profile along that path according to certain behaviours. The spatial path is generated by the constrained optimisation planner from a future speculated state of the vehicle such that the constrained optimisation has time to generate the spatial path before the ego vehicle reaches that state, while the motion profile can be generated in real time by the motion planner. This enables a trajectory to be planned in near-real time that satisfies the defined constraints on the ego vehicle's motion.

The term ‘motion component’ is used herein to refer to the sequence of motion variables for the ego vehicle generated by the constrained optimisation based planner as part of a planned trajectory, where the spatial path makes up a ‘spatial component’ of the same trajectory. As mentioned above, the motion component and the spatial component are determined together by the constrained optimisation, subject to both hard and soft constraints on the ego vehicle's motion. The spatial path therefore takes the motion of the ego vehicle into account. The motion component is typically not used to determine a final set of motion variables defining the movement of the ego vehicle according to the methods described herein, but instead the real-time motion planner generates a new motion profile defining the motion variables such as acceleration and velocity along the pre-determined spatial path. The term ‘motion profile’ is used generally herein to refer both to the motion component of the trajectory generated by the constrained optimisation based planner and the sequence of motion variables generated by the physics-based motion planner in real time along the spatial path.

A first aspect disclosed herein provides a computer system for planning a spatial path and a motion profile for an ego agent, the system comprising: an input configured to receive a state of the ego agent, and a trajectory generator configured to determine, based on the state of the ego agent, a first trajectory via a constrained optimization of a cost function encoding one or more soft planning constraints, subject to one or more hard planning constraints; the first trajectory comprising a spatial path and a motion component, the spatial path determined via the constrained optimization in dependence on at least one of a hard planning constraint and a soft planning constraint on the motion component; a motion planner configured to compute, based on the spatial path of the first trajectory, a motion profile for the ego agent satisfying one or more constraints of the motion planner.

A first aspect herein provides a computer system for planning a spatial path and a motion profile for an ego agent, the system comprising an input configured to receive a state of the ego agent, and a trajectory generator configured to determine, based on the state of the ego agent, a first trajectory via a constrained optimization of a cost function encoding one or more soft planning constraints, subject to one or more hard planning constraints; the first trajectory comprising a spatial path and a motion component, the spatial path determined via the constrained optimization in dependence on at least one of a hard planning constraint and a soft planning constraint on the motion component; a motion planner configured to compute, based on the spatial path of the first trajectory, a motion profile for the ego agent satisfying one or more constraints of the motion planner.

The trajectory generator may comprise a context detector configured to determine whether to engage the trajectory generator, wherein the trajectory generator is engaged only if predefined engagement criteria are met.

The motion planner may be configured, when the trajectory generator is not engaged, to compute a motion profile for a default reference path.

The computer system may comprise: combining the spatial path of the first trajectory with at least one previous spatial path to generate a stitched spatial path, and computing the motion profile along a smooth spatial path, wherein the smooth spatial path is generated via spline-fitting applied to the stitched spatial path.

The trajectory generator may comprise a speculation module configured to determine a speculated future state of the ego agent, wherein the first trajectory is generated from a speculated future state of the ego agent.

The motion planner may be configured to compute the motion profile for the ego agent from an actual state of the ego agent corresponding to the speculated future state of the ego agent.

The motion planner may be a physics-based planner configured to implement one or more behaviours in dependence on a state of the ego vehicle and the spatial path.

The motion planner may be configured to implement one or more behaviours of the ego vehicle in dependence on a state of at least one further agent.

The trajectory generator may comprise a path generation component configured to perform non-linear programming to optimise the cost function subject to the hard planning constraints.

The computer system may be implemented as part of an autonomous vehicle stack, wherein the motion planner is configured to output the motion profile to a controller of the autonomous vehicle.

The motion planner may be configured to output the motion profile and the smooth spatial path to a controller of the autonomous vehicle.

A second aspect herein provides a computer-implemented method of planning a trajectory for an ego agent, the trajectory comprising a spatial path and a motion profile, the method comprising: receiving a state of the ego agent; computing, based on the state of the ego agent, a first trajectory via a constrained optimisation of a cost function encoding one or more soft planning constraints, subject to one or more hard planning constraints, wherein the first trajectory comprises a spatial path and a motion component, the spatial path determined via the constrained optimisation in dependence on at least one of a hard planning constraint and a soft planning constraint on the motion component; computing, based on the spatial path, a motion profile for the ego agent, satisfying one or more motion constraints of the motion planner.

The method may comprise receiving a state of at least one further agent; wherein the first trajectory is computed based on the state of the ego agent and the state of the at least one further agent.

The at least one further agent may comprise a forward agent, positioned ahead of the ego agent, wherein the spatial path is an overtake path.

The state of the ego agent may comprise an ego pose comprising a position and orientation of the ego agent; and one or more ego motion variables defining kinematic properties of the ego agent.

The ego motion variables may comprise velocity, acceleration and jerk.

The spatial path may comprise a sequence of ego poses corresponding to the ego pose at each timestep of a sequence of N timesteps, wherein the motion profile comprises a sequence of motion variables corresponding to the ego motion variables at each timestep.

The initialisation path may be generated based on a geometry-based heuristic applied to a road layout.

The initialisation path may be generated by a trained neural network.

Minimisation of the cost function may encourage progress along a reference path.

The cost function may encode at least one secondary objective relating to safety and/or comfort.

The planning constraints may comprise kinematic constraints and/or collision avoidance constraints.

The planning constraints may further comprise a constraint on one or more of the speed, acceleration, steering angle or jerk of the ego vehicle.

The method may comprise outputting one or more control variables corresponding to the spatial path and motion profile to a controller of the ego agent to implement the spatial path and motion profile.

The motion constraints may comprise at least a constraint on a time headway gap between the ego agent at the at least one further agent.

A further aspect herein provides a computer program comprising machine-readable instructions, which, when executed by one or more computer processors, cause the processors to carry out any method disclosed herein.

### BRIEF DESCRIPTION OF FIGURES

To assist understanding of the present invention, and to show how embodiments of the same may be carried into effect, reference is made by way of example only to the accompanying drawings, in which:

FIG. 1 shows a schematic block diagram of an autonomous vehicle stack;

FIG. 2 shows a schematic block diagram of a planning method using an optimization-based planner and a motion planner;

FIG. 3 shows a schematic block diagram of a planner that uses a context detector to engage a trajectory generator;

FIG. 4 shows a process of determining whether to engage a trajectory generator;

FIG. 5 shows a process of determining whether to disengage a trajectory generator;

FIG. 6 shows an example overtake maneuver planned by a trajectory generator;

FIG. 7 shows the determination of a speculated pose for an ego vehicle;

FIG. 8 is a flow chart showing the process of determining a speculated pose for an ego vehicle;

FIG. 9 shows the transformation of a pose between a global reference frame and a path reference frame; and

FIG. 10 is a schematic block diagram showing the inputs and outputs of the trajectory generator.

### DETAILED DESCRIPTION

Described below is a planning system for autonomous vehicles and other forms of mobile robots, to allow planning of trajectories in a range of scenarios. An example autonomous vehicle stack and its components will first be described for context. However, the planning methods and systems described below can equally be applied to other forms of mobile robot.

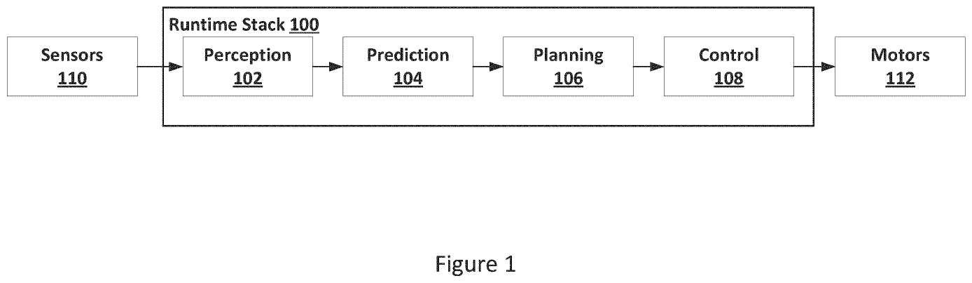

FIG. 1 shows a highly schematic block diagram of a runtime stack 100 for an autonomous vehicle (AV). The run time stack 100 is shown to comprise a perception stack 102, a prediction stack 104, a planner 106 and a controller 108.

The perception stack 102 receives sensor outputs from an on-board sensor system 110 of the AV.

The on-board sensor system 110 can take different forms but generally comprises a variety of sensors such as image capture devices (cameras/optical sensors), LiDAR and/or RADAR unit(s), satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and any external actors (vehicles, pedestrians, cyclists etc.) within that environment.

Hence, the sensor outputs typically comprise sensor data of multiple sensor modalities such as stereo images from one or more stereo optical sensors, LiDAR, RADAR etc.

Stereo imaging may be used to collect dense depth data, with LiDAR/RADAR etc. providing potentially more accurate but less dense depth data. More generally, depth data collection from multiple sensor modalities may be combined in a way that respects their respective levels (e.g. using Bayesian or non-Bayesian processing or some other statistical process etc.). Multiple stereo pairs of optical sensors may be located around the vehicle e.g. to provide full 360° depth perception. This provides a much richer source of information than is used in conventional cruise control systems.

The perception stack 102 comprises multiple perception components which co-operate to interpret the sensor outputs and thereby provide perception outputs to the prediction stack 104.

The perception outputs from the perception stack 102 are used by the prediction stack 104 to predict future behaviour of the external actors.

Predictions computed by the prediction stack 104 are provided to the planner 106, which uses the predictions to make autonomous driving decisions to be executed by the AV in a way that takes into account the predicted behaviour of the external actors.

The planner 106 implements the techniques described below to plan trajectories for the AV and determine control actions for realizing such trajectories. In particular, a core function of the planner 106 is to determine a series of control actions for controlling the AV to implement a desired goal in a given scenario. In a real-time planning context, a scenario is determined using the perception stack 102 but can also incorporate predictions about other actors generated by the prediction stack 104. A scenario is represented as a set of scenario description parameters used by the planner 106. A typical scenario would define a drivable area and would also capture predicted movements of any obstacles within the drivable area (such as other vehicles) along with a goal. A goal would be defined within the scenario, and a trajectory would then need to be planned for that goal within that scenario. In the following, obstacles are represented probabilistically in a way that reflects the level of uncertainty in their perception within the perception stack 102.

For example, the goal could be to enter a roundabout and leave it at a desired exit; to overtake a vehicle in front; or to stay in a current lane at a target speed (lane following). The goal may, for example, be determined by an autonomous route planner (not shown). A default goal may be to follow a drivable path of the AV as determined by a route planner. Progress towards the goal would in this case be measured as progress towards some future point along the drivable path.

The controller 108 executes the decisions taken by the planner 106 by providing suitable control signals to on-board actuators 112 such as motors of the AV. In particular, the controller 108 controls the actuators in order to control the autonomous vehicle to follow a trajectory computed by the planner 106.

The planner 106 plans over acceleration (magnitude) and steering angle control actions simultaneously, which are mapped to a corresponding trajectory by modelling the response of the vehicle to those control actions. This allows constraints to be imposed both on the control actions (such as limiting acceleration and steering angle) and the trajectory (such as collision-avoidance constraints), and ensures that the final trajectories produced are dynamically realisable. The planner 106 will determine an optimal trajectory and a corresponding sequence of control actions that would result in the optimal trajectory according to whatever vehicle dynamics model is being applied. The control actions determined by the planner 106 will not necessarily be in a form that can be applied directly by the controller 108 (they may or may not be). Ultimately, the role of the planner 106 is to plan a trajectory and the role of the controller 108 is to implement that trajectory. The term “control data” is used herein to mean any trajectory information derived from one of both of the planned trajectory and the corresponding series of control actions that can be used by the controller 108 to realize the planner's chosen trajectory. For example, the controller 108 may take the trajectory computed by the planner 106 and determine its own control strategy for realizing that trajectory, rather than operating on the planner's determined control actions directly (in that event, the controller's control strategy will generally mirror the control actions determined by the planner, but need not do so exactly).

The planner 106 will continue to update the planned trajectory as a scenario develops.

Hence, a trajectory determined at any time may never be realized in full, because it will have been updated before then to account for changes in the scenario that were not predicted perfectly.

These functions of an example planner 106 will now be described in further detail.

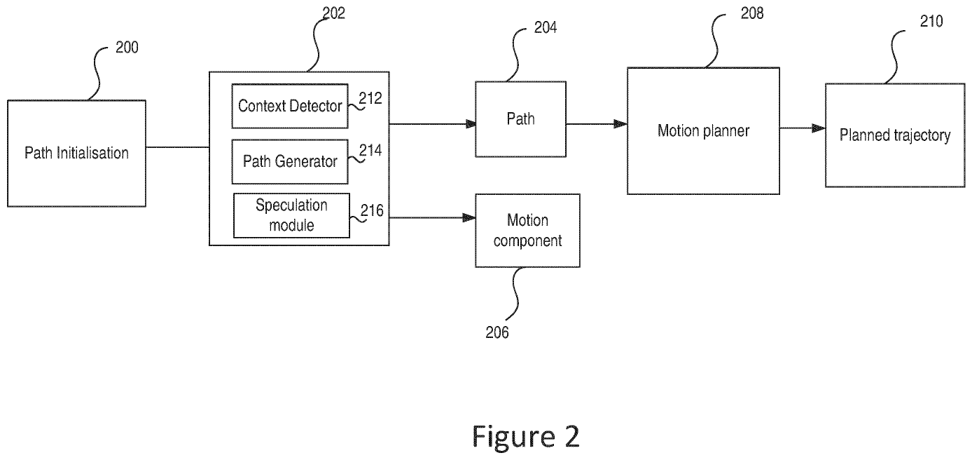

FIG. 2 shows a schematic block diagram of an example planning system according to the present invention. The example planner shown in FIG. 2 uses two different planning sub-components. The first is a trajectory generator 202 that plans a trajectory based on the state of the AV and its environment and predictions for external agents (not shown in FIG. 2), by applying optimisation-based planning. The state of the AV at a given point in time comprises the position of the AV as well as its orientation at that time, as well as the extent of the vehicle in space (i.e. the vehicle's ‘footprint’ or ‘size’), which is generally constant in time.

The trajectory is generated within a road layout in which the AV is driving. The road layout may use predetermined map data and/or information from the perception stack 104. The trajectory generator is a ‘free space’ planner in the sense that it can generate any possible trajectory within the road layout. This differs from planners that generate planned motion along a particular path, such as the motion planner 208, described below. The trajectory generator comprises multiple sub-components, including a context detector 212, which determines whether to engage the trajectory generator 202, a path generator 214 that uses constrained optimisation techniques to generate a spatial path 204 to be consumed by a motion planner 208, and a speculation module 216 that determines a speculated pose of the ego vehicle from which to plan. Each of these components is described in more detail below.

The state of the environment is determined from perception outputs computed by the perception stack 102 based on sensor data, while predictions for other agents of the scenario, including predicted positions and kinematic properties such as speed and acceleration for each agent, are determined by the prediction stack 104. The optimisation-based trajectory generator 202 may receive a path initialisation, with the optimisation using this as a seed for generating a trajectory satisfying the constraints of the planning problem. The path initialisation 200 is derived from the geometry of the road in the vicinity of the ego vehicle, as determined from the road layout. For example, where the trajectory generator 202 is implemented for overtaking, the path initialisation may be a heuristic geometric path using, for example, a raised cosine function that deviates from a centre line of the ego vehicle's driving lane to generate an initial path based on which the optimisation-based trajectory generator 202 can plan a safe and smooth path and motion profile. The initialisation path may be determined relative to a reference line such as the centre line of the ego vehicle's driving lane. For an overtake maneuver, the initialisation path can be interpolated between two reference paths of the road layout, such as the centre line of the ego's driving lane and the centre line of the oncoming lane.

In another example, the initial path may be generated by a neural network trained to approximate a solver for solving a simplified version of the planning problem as defined by the constrained optimisation problem solved by the trajectory generator 202. Such a planning architecture is described in International Patent Publication No. WO2021/152047, which is incorporated herein by reference in its entirety.

The trajectory generator 202 solves constrained optimisation problems using non-linear programming (NLP). The optimisation-based trajectory generator provides guarantees on the safety and smoothness of the resulting path by satisfying predefined constraints on the resulting path. This results in both a spatial path 204, and an associated motion component 206, that together define a planned trajectory for the AV that satisfy the planning constraints.

The path 204 and motion component 206 are defined by a set of spatial variables, such as position within a road layout or map (x,y) and a yaw angle defining the orientation of the vehicle, and a set of motion variables, including, for example, speed, acceleration and jerk. These variables are determined during constrained optimisation in order to generate a suitable spatial path and motion profile satisfying the given constraints. Constraints on both the spatial variables and the motion variables affect the spatial path 204 generated by the optimisation.

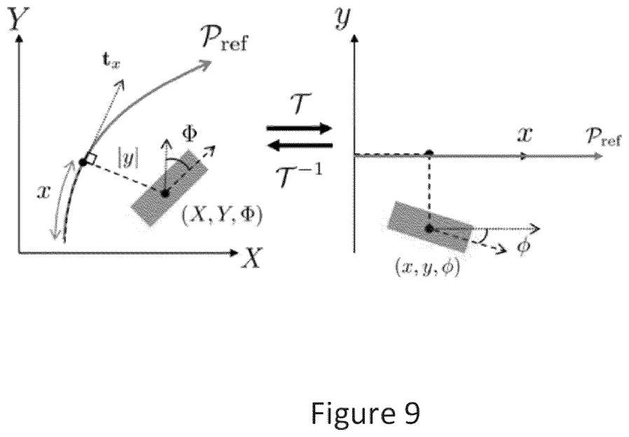

For example, physical constraints based on a maximum comfortable acceleration and steering angle limit the change in the ego vehicle's orientation and position from one time point to the next. Alternatively, the variables of the optimisation may be control variables such as acceleration and steering angle over a future time interval that defines the motion and spatial path of ego vehicle. The inputs and outputs of the trajectory generator 202 are described in more detail below with reference to FIG. 9.

The second sub-component is a motion planner 208, which is used to apply certain behaviours to the path 204 which is generated by the trajectory generator 202. This motion planner can determine suitable behaviours for the agent along the path 204, by applying certain predefined rules. For example, the motion planner may follow the provided path 204 at a constant speed by default (cruise control), but adjust this speed if the distance between the AV (also referred to herein as the ego vehicle) and a forward vehicle (also referred to herein as ‘headway’ or ‘distance headway’) is below some threshold. This adjustment in response to forward vehicle may be referred to as adaptive cruise control. Various other behaviours can be applied by the motion planner 208, motivated by safety and comfort considerations. The motion planner is a ‘classical’ or physics-based planner since it generates a motion profile along a given driveable path that satisfies physical constraints on motion. Instead of applying constrained optimisation to generate a trajectory in free space, the motion along the predefined driveable path is determined such that physical and safety constraints are satisfied by following the defined behaviours.

Another possible behaviour implemented by the motion planner ensures that a minimum time-headway gap is maintained between the ego vehicle and any other agent of the scene, such as forward agents positioned ahead of the ego vehicle along its driving lane, as well as agents in oncoming lanes, where the time-headway gap is a safety margin along a future predicted path of agents, where this headway should be maintained between all agents. This may be implemented in particular at intersections such as junctions and roundabouts. The time-headway gap is a spatial region determined based on the speed of the given vehicle and a predetermined time horizon required for safety. If the minimum time-headway gap between the ego vehicle and some external agent is not satisfied, the motion planner 208 will determine that the ego vehicle should wait until the time-headway gap increases before progressing along the driveable path. A time-headway intersection check algorithm is used to determine whether the minimum time-headway gap is present between the ego vehicle and all other agents of the scene.

Based on the checks performed by the motion planner according to the defined behaviours, the motion planner 208 may decide whether to follow a spatial path provided by the trajectory generator 202 or some default driveable path. For example, where the time-headway intersection check algorithm finds that the ego vehicle would violate its own time headway or an oncoming agents time headway if it followed a path determined by the trajectory generator 202 according to the determined motion profile, the motion planner 208 determines that the ego vehicle should continue along the reference path until the oncoming vehicle passes. In this case, the motion planner continues to check each path received from the trajectory generator 202, continuing to follow the default driveable path (reference path) until it receives a path from the trajectory generator 202 that satisfies the required time headway behaviour.

The motion profile 206 generated by the trajectory generator 202 is not used in the planner to directly determine the motion of the ego vehicle (EV), and can be discarded. In some example implementations, it may be provided as a ‘hint’ to the motion planner 208 when determining the motion profile along the path 204. Otherwise, it is discarded, and the ego vehicle's motion along the path 204 is generated entirely by the motion planner 208.

In one example use case, the motion planner 208 is applied to a default driveable path, such as a centre line of a driving lane of the AV, unless certain conditions are met in which it is necessary to plan a new path for the AV that deviates from this default, in which case the trajectory generator 202 is activated to generate a path 204 to be consumed by the motion planner 208. For example, when following a default path along the centre of a given driving lane, the default behaviour determined by the motion planner 208 may be to slow down and stop for agents ahead of the ego vehicle in the ego path to maintain a safe distance, though it might be preferable in some instances to overtake these vehicles. For example, in dense urban areas, such as residential streets, the ego path may be blocked by parked cars. In this situation, it is not desirable to stop the ego vehicle for every parked car that interrupts the default path along the centre of the ego's driving lane, and a preferred behaviour in this particular type of scenario is to overtake parked vehicles. In this case, an alternative driveable path needs to be generated, so the trajectory generator 202 is engaged when certain conditions are met to indicate that an overtake should be performed. This is just one example application of the planning architecture described herein, and an optimisation-based trajectory generator 202 can be activated for a range of scenarios for which a default path is not suitable.

Some more details of the trajectory generator 202 and how it is engaged will now be described. The following description relates to the use of the above-described planning architecture in order to plan overtaking paths, for example in the dense urban driving scenarios mentioned above, but the same system and techniques can be adapted for various types of scenarios and driving conditions for which path planning is needed.

The planner 106 is implemented to run iteratively, generating a new plan at different points in time based on the current state of the ego vehicle at that time, determined using odometry, as well as an updated state of the environment as generated by the perception system 102, and predictions for the other agents of the scene, as generated by the prediction stack 104. In the present example, the determination of whether to apply the trajectory generator 202 in planning is performed by a context detector, which runs for each iteration of the planner 106.

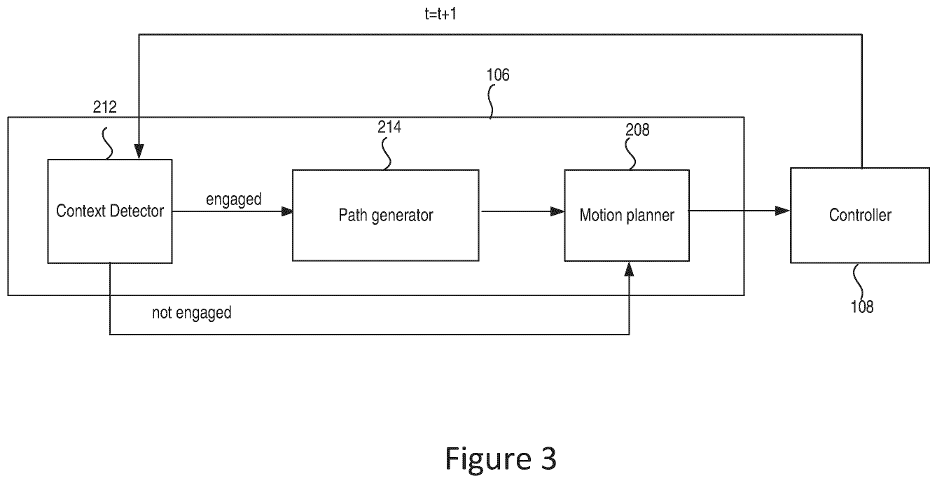

FIG. 3 shows how a context detector 212 is implemented to determine whether to engage the trajectory generator 202 for generating overtake paths, or whether a default path can be provided to the motion planner 208. The inputs to the planner 106, as described above, include the state of the ego vehicle, the states of other agents and other perception data received from the perception stack 102, as well as predictions associated with the other agents, as received from the prediction stack 104. The planner 106 also receives a map of the region in which the ego vehicle is driving. A default path, such as the central line of the ego's driving lane, can be determined based on this input data. At a timestep t of the planner, the context detector 212 carries out a number of checks based on the default path, the state of the ego vehicle, and the state of any forward vehicle on the ego's path, in order to determine whether a deviation from the default path is necessary, in this case to perform an overtake.

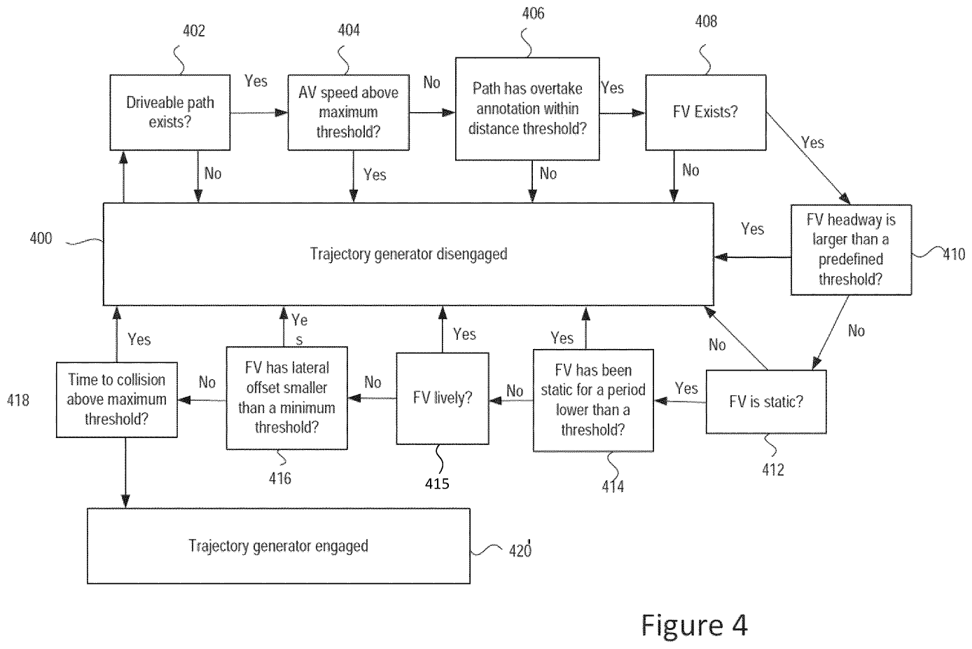

The checks required to determine whether to engage the trajectory generator 202 are described in further detail below, with reference to FIG. 4. If it is determined that the trajectory generator should be in an engaged state, planning is carried out using the path generator 214 to perform an initial constrained optimisation to plan a smooth and collision-free trajectory including a spatial path and a motion component (not shown), before passing the path component to the motion planner 208. In the case that the context detector 212 determines that the trajectory generator should not be engaged, the planner uses the default path as determined from the map and/or other input data as a driveable path to be provided to the motion planner 208 in order to compute a motion profile.

The motion planner 208 determines a motion profile along that path that is kino-dynamically feasible (i.e. satisfies constraints on velocity, acceleration and turn rate, as well as avoiding obstacles), which is passed to the controller 108 to control the ego vehicle's speed, acceleration, etc. so as to implement the planned motion along that path. The path and motion profile defining the trajectory of the ego vehicle map directly to a set of control variables, for example acceleration and steering angle, which are provided to the controller 108 to implement the motion profile. Where the controller 108 is referred to herein as receiving a trajectory and/or motion profile from the planner 106, it should be understood that the controller receives the required control variables, based on the trajectory or motion profile to implement the given motion on the ego vehicle.

The controller receives the control variables corresponding to a spatial state and motion state of the trajectory for a current timestep, for the controller to immediately implement that spatial and motion state. Although the planner generates a trajectory over multiple future timesteps, the controller only implements part of the planned trajectory before the planner is called again to generate a new planned trajectory from an updated state of the vehicle, again planning along a future planning horizon that extends beyond the immediate next step in time. The controller only implements an initial part of that new planned trajectory before the planner is called again. The motion planner 208 can be implemented in real time, such that at each planning iteration, the motion planner 208 generates a trajectory that starts from a current state of the vehicle. However, as described below in more detail, the trajectory generator 202 generates a path from a future speculated state, such that, by the time the ego vehicle actually reaches that state, a trajectory has been generated. The ego state is updated as it moves along the planned path. The planner then moves on to the next iteration, at a time step t+1, receiving the updated ego state corresponding to the time step t+1, as well as any updated states of the environment and other agents, and updated predictions for other agents.

FIG. 4 shows a set of checks performed by the context detector 212 when the trajectory generator 202 is in a disengaged state, in order to determine whether to engage a trajectory generator 202 for generating a path that deviates from the default path. As stated above, the present example uses the trajectory generator 202 specifically for generating overtake paths, and therefore the checks performed by the context detector 212 are specific to identifying suitable conditions for overtaking. However, different checks can be defined according to any driving conditions for which a particular behaviour differing from the default path is required.

In the example shown in FIG. 4, the context detector starts from a disengaged state 400, where the trajectory generator 202 is inactive, and the planner 208 uses a default path. At each time step, the context detector 212 is configured to proceed through a number of checks, where at each check, it is either determined that the trajectory generator should be disengaged, since the relevant condition for engagement associated with that check is not met, or the context detector should proceed to the next check. If, at a final check, it is determined that all conditions for engagement are met, the trajectory generator 202 is engaged and at that planning step the trajectory generator is used to generate a path for the motion planner 208 to plan along.

The first check 402 is to determine whether a driveable path exists. If no driveable path exists, it is determined that the trajectory generator 202 should not be engaged. In this case, the motion planner 208 is also disengaged, and no plan is generated. If a driveable path is present, the context detector proceeds to the next check 404.

At check 404, the context detector 212 determines whether the ego vehicle's speed is above a maximum threshold speed that allows overtakes to be initiated. This is determined based on the current state of the ego vehicle received by the planner 106 for the current planning iteration. If the ego vehicle is travelling above the maximum speed, the trajectory generator remains in a disengaged state 400. Otherwise, the context detector proceeds to the next check 406.

Check 406 determines whether the driveable path has an overtake annotation within a threshold distance of the ego vehicle. This is based on the driveable path (i.e. the default path) as determined from the map. The overtake annotations may be manually added to the given map by human annotators. Alternatively, automatic annotation may be applied by an annotation model. The annotations on the map are associated to the waypoints of the driveable path based on the positions of the annotations on the map. If the driveable path does not have an overtake annotation indicating that overtake maneuvers are allowed within an upcoming section of the path of the ego vehicle, the trajectory generator 202 is disengaged, since an overtake maneuver cannot be performed in the near future, and the default driveable path is used. If an overtake annotation is present within a certain distance of the ego vehicle's current position, the context detector proceeds to the next check 408. The check 406 is optional. In some implementations, the context detector is configured not to perform the overtake annotation check 406. The context detector is configured such that the check 406 can be enabled or disabled. Where the check 406 is not performed, then the context detector simply proceeds from the check 404 to determine that the speed is below a maximum threshold and the next check 408 to check for the presence of a forward vehicle. Check 408 determines whether a forward vehicle (i.e. another agent ahead of the ego vehicle along he driveable path) is present. This is determined based on the state of the ego vehicle as well as the states of any other agents detected by the perception stack 102 and received by the planner 106. If no forward vehicle is present, the trajectory generator 202 is disengaged, since there is no reason to perform an overtake rather than follow the default driveable path along the current driving lane. If a forward vehicle is present, the context detector proceeds to the next check 410.

Check 410, determines whether the headway (i.e. distance of the forward vehicle ahead of the ego vehicle along the driveable path) is larger than some predefined threshold determined as a suitable threshold for initiating an overtake maneuver. This check also uses the state of the ego vehicle, as well as the state of the forward vehicle, as determined by the perception stack 102. This check is performed to prevent initiation of an overtake maneuver too early, where the ego vehicle is still quite far from the forward vehicle and therefore the ego vehicle moves away from the default path too early, which can be unsafe since the ego vehicle may spend too much time outside of its own driving lane. If the forward vehicle has a headway above this predefined threshold, the trajectory generator remains disengaged. Otherwise, the context detector proceeds to the next check 412.

Check 412 determines whether the forward vehicle is static. This identifies instances where the ego encounters parked vehicles along its driving lane, for example in dense urban areas with residential streets, where many agents are parked along the side of the road such that they overlap with the ego vehicle's driving lane. In the present example, overtaking is only desired for static agents such as parked cars. The determination of whether the forward vehicle is static is based on the state of the forward vehicle as received from the perception stack 102, and the state of the ego vehicle. If the forward vehicle is found not to be static, the trajectory generator is disengaged. Otherwise, the context detector proceeds to the next check 414.

Check 414 determines whether the forward vehicle has been static for a period lower than some threshold time. Again, this check uses the state of the ego vehicle and the state of the forward vehicle for the current time step, as well as previous states of the forward vehicle, as received from the perception stack 102. This threshold time is set to an appropriate time such that the planner is sufficiently confident that the forward vehicle has stopped, and not that the forward vehicle state is incorrectly seen as static due to perception noise. If it is observed that the forward vehicle speed is below the stationary speed threshold for at least e.g. 0.5 s, then the planner has a relatively high level of confidence that the vehicle is indeed stationary and that a sudden dip in perceived speed has not been caused by an error in perception. This check may also help to exclude some cases where the forward vehicle has stopped only temporarily before continuing along its path. Where the forward vehicle is stopped only temporarily, but for a sufficiently long time that it passes the check 414, it is filtered out at the next check 415, described below. It is not desirable in the present overtake example to attempt to overtake a vehicle that is only temporarily stopped, since the forward vehicle could move off during the overtake maneuver, which could be unsafe. Therefore, if the forward vehicle has not been static for a minimum threshold time period, the trajectory generator 202 is disengaged. Otherwise, the context detector proceeds to the next check 415.

The next check 415 is a check of the ‘liveliness’ of the forward vehicle, to identify whether the forward vehicle is truly static (e.g. parked) and therefore safe to be overtaken, or is just temporarily stopped, where it may be unsafe to overtake due to the risk that the forward vehicle begins moving again before the overtake maneuver has been executed. The liveliness check 415 determines whether the forward vehicle has already been seen to move at any past timestep. If so, the forward vehicle is determined to be ‘lively’, and therefore unlikely to be parked, making it potentially unsafe to overtake. If the forward vehicle has not been observed to have moved at any past timestep, then the context detector proceeds to the next check 416.

Check 416 determines whether the lateral offset of the forward vehicle is smaller than some minimum threshold. The lateral offset is measured from the default driveable path, and is based on the state of the forward vehicle as received from the perception stack 102. This indicates when the forward vehicle is positioned off the centre of the driving lane, indicating, that the forward vehicle is likely to be parked, and therefore safe to overtake, since it is positioned towards the edge of the road, rather than the driving lane. If the lateral offset is below the minimum threshold distance, the trajectory generator 202 is disengaged. Otherwise, the context detector proceeds to the final check 418.

Check 418 determines whether the time to collision for the ego vehicle is above some predefined maximum threshold. This measure indicates the time it would take to collide with the forward vehicle travelling at its current speed along the default path, based on the respective states of the ego vehicle and the forward vehicle. If the time to collision is very small, this indicates that the ego vehicle is at risk of colliding with the forward vehicle if it does not change path or brake to avoid collision. If the time to collision is very large, the ego vehicle can safely continue along its current path without changing its speed for some time, and there is no need for an alternative action. In this case, an overtake is only required for forward vehicles that the ego vehicle is approaching closely. There is no reason to begin planning an overtake maneuver from a point at which the ego vehicle can safely continue along its current path for a given time interval, since this prolongs the overtake maneuver which may be unsafe. Therefore, if the time to collision is above some predefined threshold, the trajectory generator remains disengaged, and the planner 106 uses the default driveable path, based on which the motion planner determines a suitable trajectory along that path, at least until the ego vehicle is closer to the forward vehicle. It should be noted that even if the forward vehicle headway is below its predefined threshold as determined at check 410, the time to collision may be above its maximum threshold, for example if the ego vehicle is travelling very slowly. If the time to collision is below the maximum threshold, then all conditions are met for the trajectory generator to be engaged for performing an overtake, and the context detector switches to a trajectory generator engaged state 420.

As noted above, performing overtakes in urban environments is just one possible application of the architecture described herein. Furthermore, the checks described in FIG. 4 are specific conditions defining when to perform an overtake, limited to overtaking static vehicles. Even within the context of performing an overtake, other conditions may be included as checks, for example to take into account oncoming vehicles, such that the trajectory generator 202 is not activated to perform an overtake when an oncoming vehicle is present, or other agents such as pedestrians or cyclists, for example where the trajectory generator is not engaged for performing an overtake if a pedestrian is seen crossing the road ahead of the ego vehicle.

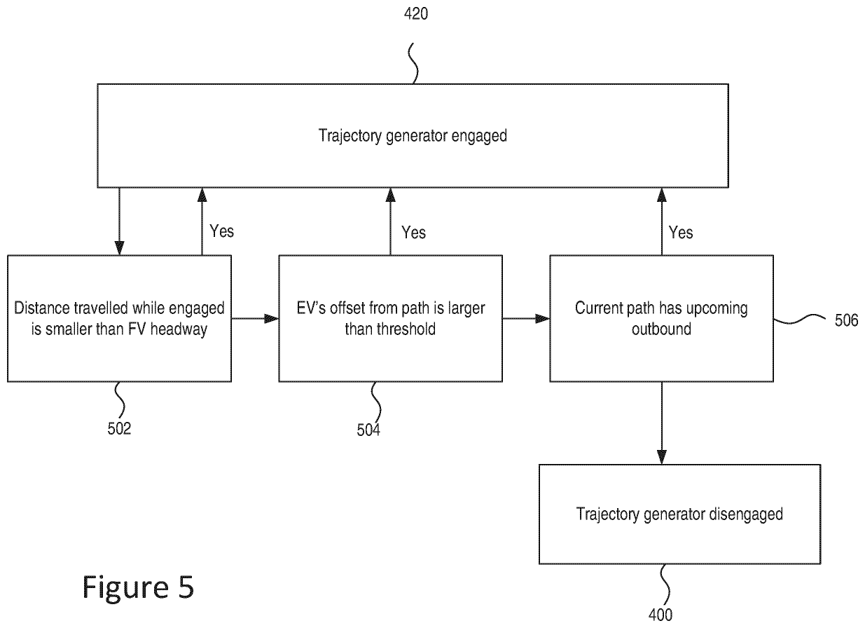

When the trajectory generator 202 is in the engaged state 420, the context detector 212 performs a different set of checks to determine whether the trajectory generator 202 should be disengaged. FIG. 5 shows this set of checks.

The context detector 212 starts the checks in the engaged state at a time step t. If, at a time step t, the trajectory generator is instead disengaged, the process described above with reference to FIG. 4 is used to determine whether to engage the trajectory generator 202.

The first check 502 determines whether the distance travelled while the trajectory generator 202 has been in an engaged state 420 is smaller than the forward vehicle's headway at the point at which the trajectory generator was engaged. The distance travelled is computed as the Euclidean distance between the point at which the trajectory generator 202 is engaged and the current position of the ego vehicle. This distance is a good approximation of the distance actually covered by the ego vehicle in most situations, and can be computed quickly. This determination is based on the ego vehicle's current and past states, as well as the state of the forward vehicle. If not, this means that the ego vehicle has not yet passed the forward vehicle, so the overtake maneuver cannot yet be complete, in which case the trajectory generator 202 remains engaged. If the distance travelled by the ego vehicle is greater than the forward vehicle's headway, this means that the ego vehicle has at least travelled far enough along the path to have passed the forward vehicle, so this requirement for completing the overtake is met. The context detector can then proceed to the next check 504.

Check 504 determines whether the lateral offset of the ego vehicle from the original (default) driveable path is larger than a threshold. This determination is based on the ego vehicle's state and the driveable path. This indicates whether the ego vehicle has pulled back into its normal lane position after the overtake has been performed. If the ego vehicle has a lateral offset greater than a threshold, the ego vehicle has not fully pulled back into its lane position and the overtake is not yet complete. In this case, the trajectory generator 202 remains in the engaged state 400. If the ego vehicle's lateral offset is determined to be below some threshold distance to the driveable path, then the ego has pulled back into its normal position, and this requirement for completing the overtake is met. The context detector can then proceed to the final check 506 for disengaging the trajectory generator 202.

Check 506 determines whether the current path planned by the trajectory generator has an upcoming outbound, i.e. an upcoming overtake section of the path that deviates from the driveable path. If the trajectory generator's path has an outbound, this indicates that there is another parked vehicle to be overtaken ahead of the forward vehicle currently being overtaken (or which has just been overtaken). This may happen, for example, where the ego vehicle pulls into a gap between two agents after overtaking the second agent because the distance between the two agents was large enough that it would be safer to return to the driving lane than to continue the overtake maneuver in the oncoming lane. However, the planner intends to also overtake the first agent imminently, such that it is preferable that the trajectory generator remains engaged throughout the two overtake maneuvers, rather than disengaging the trajectory generator and restarting the process from check 402 above. In this case, even where the ego vehicle has returned to the driveable lane (or within a predefined threshold of the driveable lane), as determined from the previous check 504, because there is an immediate overtake path as determined from the trajectory generator, the trajectory generator needs to remain engaged for the second overtake. The context detector is configured to remain in the trajectory generator engaged state in this case. Otherwise, where the current path generated by the trajectory generator 202 has no upcoming outbound, the trajectory generator is switched to a disengaged state 400.

As mentioned for FIG. 4 above, the checks described in FIG. 5 are just an example of conditions that may be imposed for the planner to switch from the trajectory planner 202 configured to generate overtake maneuvers to a default driving lane path. Other checks involving oncoming agents, pedestrians or other road users, or moving forward vehicles, could be implemented depending on the required application. Similarly, the trajectory generator 202 is not limited to planning overtake paths in urban driving scenarios, and may be used to implement other driving behaviours in other types of driving scenarios, such as roundabouts, highway driving, etc.

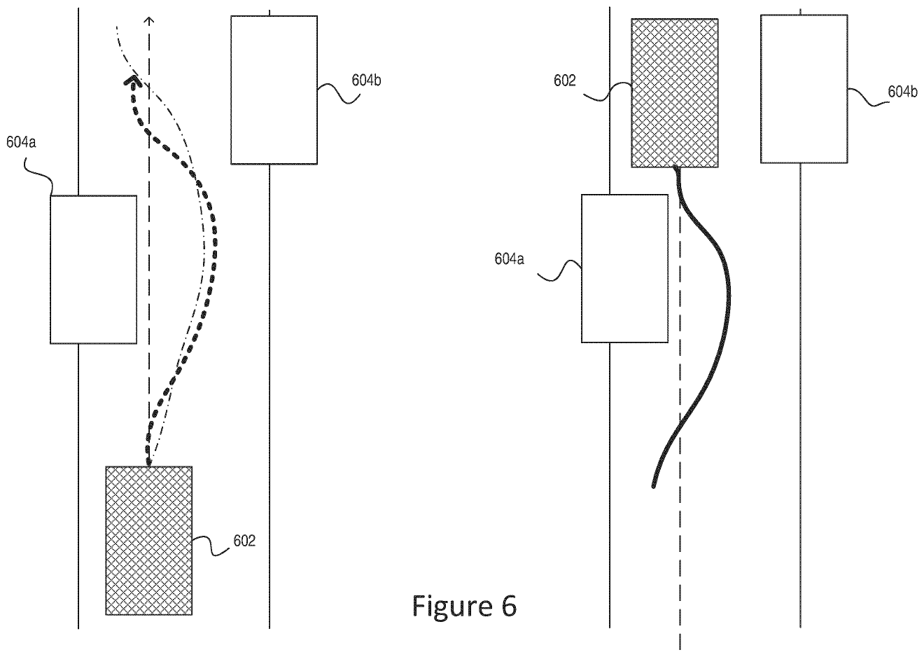

FIG. 6 shows an example urban driving scenario in which the above-described planning method can be applied to switch between a default mode in which the motion planner 208 uses a default drivable path along which to generate motion profiles, and an overtake mode, in which the path generation module 214 of the trajectory generator 202 is used to generate a path along which the motion planner 208 plans. Shown on the left is an ego vehicle 602 following a driveable path along a driving lane, approaching two parked cars, 604a, 604b. Note that the driving scenario is shown in a path frame of reference, i.e. the position of the vehicles and the road structure are represented relative to the driveable path, which is shown as a dashed straight line. The path reference frame is described in further detail below. On the left, the ego vehicle is approaching the first parked agent 604a on the left. The context detector performs the checks described in FIG. 4 to determine if the trajectory generator should be engaged. If all criteria are met, i.e. if the ego vehicle's speed and position relative to the forward vehicle are such that an overtake is appropriate, as defined by the conditions shown in FIG. 4, and if an overtake is allowed on the particular driving lane according to map annotations, then the trajectory generator is engaged at the point shown on the left of FIG. 6.

The path generator 214 runs the constrained optimisation to generate a suitable trajectory for the ego vehicle, for a set time interval into the future, also referred to as a ‘planning horizon’.

As will be described in further detail below, the trajectory generator may plan a trajectory starting from a speculated future ego state, such that the planned path is available by the time the ego vehicle reaches that future point. From the initial state, the trajectory generator produces a future spatial path and motion profile for the ego vehicle that avoids collision with the agents 604a, 604b while satisfying various constraints. The trajectory generator 202 is provided with a path initialisation, shown by the alternating dashed/dotted line. In the present example, the initialisation path is a raised cosine function, which is a geometric, heuristic-based function for an overtake path. As mentioned above, initialisation paths could alternatively be generated by other methods, for example by a trained function approximator configured to generate an initialisation trajectory for the trajectory generator, which may be in the form of a trained neural network.

Mathematical details of the constrained optimisation problem solved by the trajectory generator 202 are described in further detail below. An example path that could be generated by the trajectory generator 202 is shown by a bold dotted line on the left of FIG. 6. However, it should be noted that, while the trajectory generator 202 is engaged, a new trajectory is generated at each planning step, based on an updated state of the ego vehicle (which may be a speculative state, as described in more detail below), so the path shown on the left of FIG. 6 is not necessarily the path that the ego vehicle eventually takes. The context detector continues to perform checks as described in FIG. 5 at each step of the planner, but the trajectory generator 202 remains engaged at least until the overtake of the agent 604a is complete.

Shown on the right of FIG. 6 is the ego vehicle 602 having completed the overtake of the agent 604a. As shown by the solid line, the ego vehicle has completed the overtake maneuver and has now returned to a position close to the driveable path. As described in FIG. 5, if the state of the ego vehicle relative to the vehicles 604a and 604b and relative to the driveable path are such that the trajectory generator 202 should be disengaged, the context detector switches to a disengaged state, and the ego vehicle continues along the driveable path with its motion being determined by the motion planner 208. As described above, the path actually taken by the ego vehicle 602 over the given time interval does not necessarily correspond to any individual path planned by the trajectory generator 202 when it was engaged, but is an aggregation of the actions taken by the ego over the time interval to implement partial trajectories in line with the planned paths produced by the trajectory generator 202 and motion determined by the motion planner 208 at each planning iteration over that time interval.

Constrained optimisation problems can take some time to converge to a solution, making it difficult to generate planned trajectories in real-time, or on a time scale which would allow the trajectory generator to determine a planned trajectory from the current ego state for immediate implementation by the controller 112. In order to deal with this delay in generating paths, the planner uses a technique referred to herein as ‘speculation’ in order to infer about a future state of the ego vehicle over a period of time, referred to herein as the speculation time, and sets the future state of the ego vehicle to be used by the trajectory generator 202. A default speculation time may be set at 1 second, for example. The planner 106 sets that state to be used by the trajectory generator 202 from which to plan, such that when the ego vehicle reaches that point, a path is available.

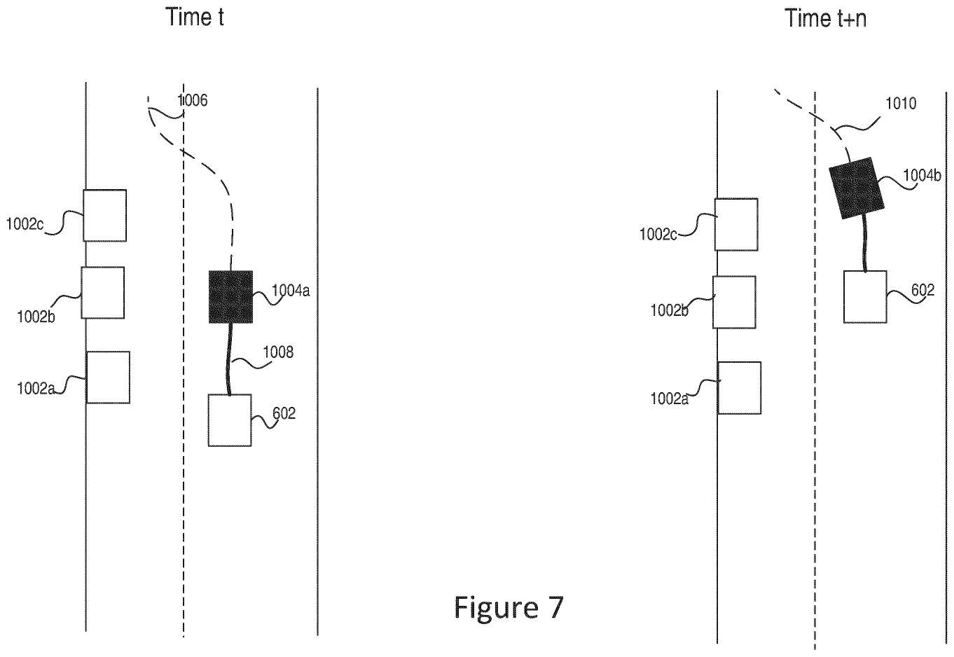

FIG. 7 shows an example application of speculation during planning of an overtake maneuver using the methods described herein. An example driving scenario is shown at a first timestep t. At the first timestep, the ego vehicle 602 has begun an overtake of a set of parked vehicles 1002a, 1002b, 1002c, along an overtake path. As noted above, it is not possible for the constrained optimisation to be performed quickly enough that a plan can be generated from the current timestep t for immediate implementation by the ego vehicle 602 from that current state. If a trajectory is generated from the current state of the ego vehicle 602 at time t, the ego vehicle state will have already updated by the time that trajectory is generated and provided to the motion planner to determine a motion profile for the ego vehicle. To address this, the planner uses a speculated future pose 1004a (i.e. position and orientation) of the ego vehicle 602 as the initial state for a trajectory generated at the current timestep, such that when the ego vehicle reaches that point along the planned path, a path is available.

The path 1008 is the path along which the speculated ego pose is determined. As described further below, this could be a default driveable path, or a path already generated by the planner based on a previous speculated state of the ego vehicle.

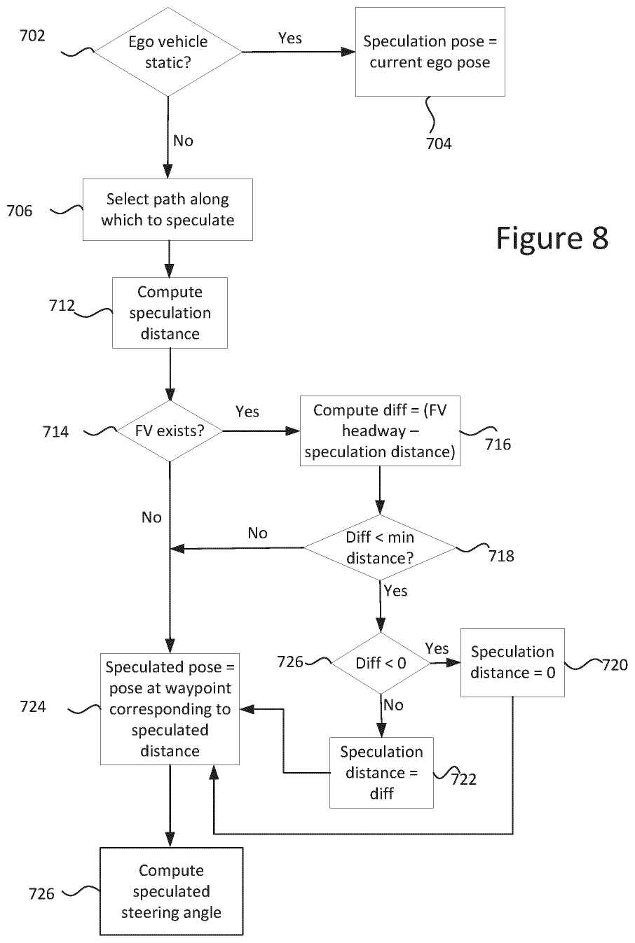

Based on the speculated pose 1004a, the trajectory generator 202 determines a trajectory from the future state of the ego vehicle. When the ego vehicle reaches the speculated pose (or an equivalent point along its path), this trajectory (and the spatial path 1006 derived from this trajectory) is available to the motion planner, to determine a suitable motion profile for the ego vehicle. The process of determining the speculated pose 1004a is described in further detail below, with reference to FIG. 8.

Once a further path 1006 is generated from the speculated pose, as described below, this further path 1006 is appended or ‘stitched’ to the existing path 1006 generated based on the trajectory generator 202 outputs up to that point. Successive trajectory generator paths are generated based on respective speculated states of the ego vehicle at a relative future time, and each generated path is stitched to the path already generated. The ‘stitched’ path based on all the paths generated by the trajectory generator 202 is then provided to the motion planner 208 to determine a motion profile for the ego vehicle 602 along that path. A Catmull-Rom spline is fit to the stitched path and smoothing is applied, resulting in a smooth path being generated based on the path 1006 output by the trajectory generator 202 at the current timestep, combined with previous paths generated by the trajectory generator 202.

A later timestep t+n is shown on the right of FIG. 7, where the ego vehicle 602 has reached the point along the path of the previously speculated pose 1004a. In the example shown, the ego vehicle has followed the planned path from the timestep t to the later timestep t+n and has the same pose as the speculated pose 1004a. A spatial path 1006 was determined from the trajectory generated by the trajectory generator 202 at the speculated pose 1004a by fitting a Catmull-Rom spline to the trajectory, and this path is stitched to the existing path generated at previous timesteps to generate a stitched path. As described above, any further paths generated after timestep t are also stitched to the path as they are generated by the trajectory generator 202. As shown in FIG. 7, the bold path starting from the ego vehicle 602 at timestep t+n includes at least a part of the path generated at the speculated state 1004a at time t. The stitched path generated up to timestep t+n then provides the spatial component along which the motion planner 208 determines a motion profile, defining the speed, acceleration, and steering of the ego vehicle following that spatial path. At timestep t+n, the ego vehicle implements controls for following the stitched generated path based on the trajectory generator for the speculated ego pose at time t and any subsequent speculated ego poses.

At timestep t+n, the speculation process is repeated for a further speculated future ego vehicle state 1004b, based on the ego vehicle continuing along the path 1006. From the given speculated pose 1004b, the trajectory generator outputs a planned trajectory, from which a spatial path 1010 is derived by spline-fitting. This spatial path 1010 is available to the motion planner to determine a motion profile for the ego vehicle to implement once it reaches the speculated state 1004b or an equivalent point along its path.

Speculation focuses on the pose and speed of the ego vehicle at the future timestep, where pose specifies the position and orientation of the ego vehicle within the two dimensional map (i.e. a position (x, y) and a yaw angle φ).

A speculated pose is determined as shown in FIG. 8. Speculation may be performed by a speculation module 216 of the trajectory generator 202. The speculation time is set to a suitable initial value. First, a check 702 is done to determine if the ego vehicle is static. If the ego vehicle is static, then the current pose of the ego vehicle is set as the speculation pose to be used by the trajectory generator 202, as shown in step 704, since the ego vehicle is not expected to move within the speculation time. Otherwise, at step 706, a path is selected along which the speculation of the ego state is performed. If an existing trajectory generator path is available, for example as generated by the trajectory generator 202 at a previous planning step, then this is used as the path along which speculation is performed. Otherwise, the default driveable path is used.

The driveable path and the path generated by the trajectory generator 202 each comprise multiple waypoints along the path, as well as curvatures and speeds, with each waypoint defining the pose (position and orientation) of the ego vehicle at that point along the path. The pose defines the position and orientation of the ego vehicle at each waypoint of the path, as described above. Each waypoint is also associated with a speed, defining a speed limit applied to the ego vehicle at that waypoint. These speed limits are typically the speed limit of the road lane, as determined from the map. The actual speed of the ego vehicle 602 along the path is defined by the motion planner such that it does not exceed the defined speed limit at each waypoint. The waypoints are defined at regular time intervals, for example every 0.01 seconds, or any other time interval that provides sufficient density to define the path.

At step 712, a speculation distance is computed by multiplying the speed of the ego vehicle by the speculation time. The speculation distance is therefore the distance the ego vehicle is expected to travel within the speculation time, at its current speed, or its speculated speed as described below.

At step 714, a check is performed to determine if a forward vehicle is present along the path. If a forward vehicle is present, the forward vehicle headway (i.e. the distance between the ego vehicle and the forward vehicle) is determined, and the difference between the forward vehicle headway and the speculation distance is computed at 716. This compares the speculation distance, i.e. how far along the path the planner begins to plan, with the forward vehicle's headway. A predefined minimum distance is used to determine whether the speculation distance should be reduced.

At step 718, a check is performed to determine whether the difference between the forward vehicle headway and the speculation distance is greater than the minimum distance. In general, the ego vehicle decelerates as it approaches a parked vehicle in front of it. However, in the present example, the speculation distance is determined based on an assumption of constant speed. This assumption therefore does not hold true when approaching a parked vehicle from behind. The speculated state may ‘overshoot’ if this assumption is applied, leading to the speculated pose potentially being in collision with the forward vehicle. This check is therefore performed to ensure that the speculated pose maintains sufficient headway from the forward vehicle.

In alternative implementations, the speculation distance may be determined based on a model of ego motion that takes into account acceleration, rather than assuming that the ego vehicle proceeds at a constant speed. In this case, deceleration would be taken into account as the ego vehicle approaches the parked forward vehicles, and the check of step 718 would not be necessary.

If the computed difference between the forward vehicle's headway and the speculation distance is greater than the predefined minimum distance, the predefined speculation distance remains the same, since this allows the ego sufficient distance from the forward vehicle to plan an appropriate path to avoid the forward vehicle. Otherwise, a second check 726 is performed to determine whether the speculation distance is greater than the forward vehicle headway (i.e. whether the computed distance is less than zero). If so, the speculation distance is defined as zero (step 720). Otherwise, the speculation distance is defined as the difference between forward vehicle headway and the required minimum forward vehicle headway (step 722). In other words, if a distance of at least 5 metres is required to be maintained between the ego vehicle and the forward vehicle, and the forward vehicle headway is, for example, 15 metres, then the speculation distance is set at 15 m−5 m=10 m.

At step 724, the speculated pose is computed. This is done by setting the waypoint corresponding to the determined speculation distance (i.e. the waypoint closest to a point ahead of the ego vehicle along the relevant path by the speculation distance), and selecting the pose associated with that waypoint as the ego vehicle's pose.

At step 726, a speculated steering angle associated with the speculated pose is determined. This is done by deriving the steering angle from the curvature of the ego vehicle's path at that waypoint. The determined speculated steering angle is then used to initialise the first steering angle control action of the trajectory generator 202.

To determine the ego vehicle's speed, as used to compute the speculated pose above, one option is to assume that the speed of the ego vehicle remains constant, such that the current speed of the ego vehicle is used to speculate the ego's pose.

An alternative option is to apply a parametric model to determine the speed by selecting from multiple possible behaviours. In the present example, the ego speed is selected as the lowest speed among three candidates, implementing basic behaviours: ramp up to the target speed, keep safe distance to the forward vehicle, and drive at road speed.

The model for speculated speed depends on the following parameters:

$${s}_{ev} ( t ) : EV ’ s speed at time t \cdot Unit : [ \frac{m}{s} ] .$$

$${a}_{max} : EV ’ s maximum acceleration \cdot Unit : [ \frac{m}{{s}^{2}} ] .$$

$${b}_{max} : EV ’ s maximum deceleration \cdot Unit : [ \frac{m}{{s}^{2}} ] .$$

$${j}_{min} : EV ’ s minimum jerk \cdot Unit : [ \frac{m}{{s}^{3}} ] .$$

$${d}_{fv} ( t ) : Distance to the FV at time t \cdot Unit : [ m ] .$$

$${s}_{n} : nominal path speed \cdot Unit : [ \frac{m}{s} ] .$$

$$r : reaction time ( Unit : [ s ] ) computed as r = \frac{{b}_{max}}{{j}_{min}} .$$

Based on these parameters, three candidate speeds are considered:
1. Safe Speed sₛ(t): Speed at time t that allows the ego vehicle to stop without colliding with the forward vehicle, computed as:

sₛ=−r·bₘₐₓ+\sqrt{(r·bₘₐₓ)²+(s_{fv})²+2.0·bₘₐₓ·d_{fv}}
2. Ramp-up speed sᵤ(t): Possible speed increment respecting both aₘₐₓ and sₙ, computed as:

$${s}_{u} ( t ) = {s}_{ev} ( t ) + {b}_{max} \cdot ( 1. - \frac{{s}_{ev}}{{s}_{n}} )$$

3. Nominal speed sₙ: Speed allowed by the path at the ego vehicle's position (this may be determined based on map annotations).

The speculated speed value is the minimum of the above three speed candidates:

S_{spec}=min(sₛ,sᵤ,sₙ).

Once a speculated pose is determined (based on either the nominal or speculated ego speed as above), the trajectory generator is used to determine a path from that ego pose, with that path being available to the motion planner 208 by the time the ego reaches that point along the path.

The motion planner 208 can generate suitable behaviours along the provided path in real-time or near-real-time, such that the motion of the ego vehicle can be generated once it reaches the speculated pose described above, satisfying predefined behavioural rules implemented by the motion planner 208, such as slowing down based on the headway of forward vehicles, etc. The above-described planning architecture, comprising a trajectory generator 202 implementing constrained optimisation-based planning that feeds into a motion planner 208, operates over two distinct time-scales. The trajectory generator 202 operates over a speculation time in order to determine a path from some future state of the ego vehicle, while the motion planner is used once the ego vehicle is at that state to plan the ego's motion profile in real time, based on the state of the ego vehicle as well as the states of any other vehicles of the scene.

As mentioned above, the trajectory generator 202 uses constrained optimisation to generate a trajectory starting from a given ego state that meets constraints on safety, comfort, etc, and achieves other objectives such as progress towards a planning goal such as following a driveable path.

Some mathematical details of an example constrained optimisation problem solved by the trajectory generator 202 for planning an ego trajectory will now be provided. Safety considerations and rules of the road are encoded as hard constraints, while secondary objectives (desirable conditions of the planned trajectories that are not strictly required) are encoded as terms of a cost function to be optimised. As mentioned above, the optimisation can be initialised in multiple ways, including a geometry-based heuristic overtake, and a function approximator trained to output a suitable trajectory initialisation for a set of input parameters describing the driving scenario. The trajectory generator 202 solves this problem to output a safe, smooth and dynamically feasible trajectory. A path 204 is determined by transforming the trajectory by fitting a Catmull-Rom spline to the trajectory.

To simplify the process of defining a planning goal, the global coordinate frame is transformed to a reference path-based representation under an invertible transform. As mentioned above and shown in FIG. 6, the state of the ego vehicle and other agents of the scenario is represented in this reference path-based representation.

A goal of the ego vehicle is defined as following a differentiable and bounded two-dimensional reference path (the default driveable path) in the global coordinate frame, P_{ref}, parameterized by the distance from the start of the path (X^{P}^{_{ref}}(λ), Y^{P}^{_{ref}}(λ)). Tangential and normal vectors of the reference path in the global coordinate frame can be obtained at any point λ along the path P_{ref} as

$${t}_{λ} = [ \begin{matrix}\frac{\partial {X}^{{𝒫}_{ref}} ( λ )}{\partial λ} \\ \frac{\partial {Y}^{{𝒫}_{ref}} ( λ )}{\partial λ}\end{matrix} ] , {n}_{λ} = [ \begin{matrix}\frac{- \partial {Y}^{{𝒫}_{ref}} ( λ )}{\partial λ} \\ \frac{\partial {X}^{{𝒫}_{ref}} ( λ )}{\partial λ}\end{matrix} ] \qquad ( 1 )$$

respectively.

The reference path can be determined using knowledge of the road layout, which may use predetermined map data (such as an HD map of the driving area), information from the perception stack 102, or a combination of both. For complex layouts in particular (such as complex junctions or roundabouts), the reference path could be learned by monitoring the behaviour of other drivers in the area over time.

FIG. 9 illustrates the transformation of a pose from the global frame to the reference path-based coordinate frame.

The invertible transform T operates on the poses, velocities and road borders, represented as polylines. Each of the individual operations is described next.

T maps poses (X, Y, Φ) in the global coordinate frame W to poses (x, y, φ) in the reference path frame Wᵣ as shown in FIG. 9.
x=projₚ_{_{ref}}[X Y] is the distance of the projection of [X Y] to P_{ref} from the beginning of the path, defined as the solution to the following optimization problem:

argmin(X−X^{P}^{_{ref}}(λ))²+(Y−Y^{P}^{_{ref}}(λ))².

Due to the nature of the optimization, no closed-form solution can be obtained for x.

$$y = \frac{1}{‖ {n}_{x} ‖} {n}_{x}^{T} \cdot \hat{y} ,$$

where nₓ is the normal vector of the reference path at λ=x as in (1), and ŷ=[X−X^{P}^{_{ref}}(x)Y−Y^{P}^{_{ref}}(x)].

$$ϕ = ∠ {t}_{x} - Φ , where ∠ {t}_{x} = arctan arctan ( \frac{\partial {Y}^{{P}_{ref}} ( λ )}{\partial {X}^{{P}_{ref}} ( λ )} {\vert}_{λ = x} )$$

FIG. 9 shows a visual representation of the transform T between the world frame of reference and the reference path-based frame, and T⁻¹, the inverse transform.

Since T is defined spatially, speeds are invariant to it: v=T(V)=V.

As will be appreciated, the inverse transformation T⁻¹ can be derived straightforwardly by applying the same geometric principles.

Agents can be represented using ellipses, axis aligned to the agent's axis, to aid the optimiser in producing smooth collision avoidance trajectories. Given an agent with a certain orientation and shape, and the desired radii of the ellipse, the ellipse is described by the parameters A, B and C such that:

A(x−x_{c})²+B(x−x_{c})(y−y_{c})+C(y−y_{c})²=1

A mathematical formulation of an example constrained optimisation as solved by the trajectory generator 202 will now be provided. The non-linear programming (NLP) implemented by the trajectory generator 202 aims to minimise a cost function ƒ(X) subject to inequality and equality constraints g(X), including hard constraints, which encode requirements, and soft constraints, which encode secondary objectives of the planner. Other implementations of constrained optimisation may instead use a reward function to encode soft constraints on the motion variables of the ego vehicle, where the reward function is maximised during the optimisation process. The effect of maximising a reward function is the same as that of minimising a cost function, and cost and reward functions may be referred to interchangeably herein. Cost functions and reward functions may also be referred to more generally herein as ‘objective functions’.

The following notation will be used for time and constraint indices:
Timestep index: i∈[1, . . . , N]
Hard constraint index: h∈[1, . . . , H]
Soft constraint index: j∈[1, . . . , M].

The optimisation problem is formulated as follows:

argminₓƒ(X,P)s.t.gₕ(X,P)≤0∀h.

The objective function ƒ(X, P) is the sum of soft constraints, while the inequality constraints gₕ are hard constraints which are strictly not to be violated.

The state X is represented as [x, y, V, θ_{yaw}]ₜ and ego vehicle controls are represented as [α, β]ₜ, where α is acceleration, and β is the steering angle, for a timestep t over a horizon of N timesteps, also referred to as a planning horizon. The x coordinate corresponds to distance along the reference path, while the y coordinate corresponds to position along a line perpendicular to the reference path. P is the set of parameters (including weights on the soft constraints of the objective function), that form part of the planner configuration.

An example multi-objective function to be minimised for an ego vehicle driving in the presence of one or more external agents is defined as follows:

$$f ( X , P ) = {\sum }_{j = 1}^{M} {f}_{j} = {f}_{goal} + {f}_{midline} + {f}_{yaw} + {f}_{last \_ yaw} + {f}_{steering} + {f}_{steering \_ velocity} + {f}_{speed} + {f}_{static \_ v} + {f}_{dyn \_ v} + {f}_{occlusion \_ v} + {f}_{left \_ border} + {f}_{right \_ border}$$

The soft constraints are:

$${f}_{goal} = {w}_{G} \cdot \frac{{( {x}_{N} - {x}_{G} )}^{2}}{{x}_{G}^{2}} .$$

This term penalises trajectories that fail to progress towards a goal position x_{G} along the path. The weight w_{G} is configurable to control the contribution of this term to the overall objective function.

$${f}_{midline} = \frac{{w}_{M}}{N} \cdot ( \frac{\sum {( {y}_{i} - {y}_{mid} )}^{2}}{{y}_{mid}^{2}} ) .$$

This term penalises trajectories that deviate from the midline of the ego driving lane. The weight w_{M} is configurable to control the contribution of this term to the overall objective function.

$${f}_{yaw} = \frac{{w}_{yaw}}{N} \cdot \sum {θ}_{i}^{2} .$$

This term penalises large yaw angles. In other words, this term encourages the ego to maintain a forward-facing position along the path. The weight w_{yaw} is configurable to control the contribution of this term to the overall objective function.

$${f}_{last \_ yaw} = \frac{{w}_{yaw}}{N} \cdot \sum {θ}_{i}^{2} .$$

This term penalises trajectories that end with a large yaw angle. In other words, this term encourages the ego to end the planned path in a forward-facing position along the path. The weight w_{last_yaw} is configurable to control the contribution of this term to the overall objective function.

$${f}_{steer} = \frac{{w}_{steer}}{N} \cdot \sum {β}_{i}^{2} .$$

This term penalises large steering angles to avoid sharp turns, which can be uncomfortable. The weight wₛₜₑₑᵣ is configurable to control the contribution of this term to the overall objective function.

$${f}_{steering \_ velocity} = \frac{{w}_{steer \_ vel}}{N} \cdot \sum {β}_{i}^{2} {v}_{i}^{2} .$$

This term penalises steering while driving at high speeds, thus avoiding high lateral accelerations which can be uncomfortable for human users. The weight w_{steer_vet} is configurable to control the contribution of this term to the overall objective function.

$${f}_{speed} = \frac{{w}_{speed}}{N} \cdot \frac{\sum {( {v}_{i} - {v}_{target} )}^{2}}{{v}_{target}^{2}} , where {v}_{target} = {v}_{max} \cdot {v}_{target}^{mul} , \\ and where {v}_{max} = ( speed\_limit , {v}_{init}^{max} ) + 0.5 ,$$

where

$${v}_{init}^{max}$$

is the maximum velocity over the initialisation trajectory of the trajectory generator, and where

$${v}_{target}^{mul}$$

is a constant factor defining the target speed relative to the maximum speed along the path. This could be set at 0.8 by default, meaning that the target speed for the ego vehicle is 80% of the maximum speed. This term encourages the ego vehicle to travel at a target speed v_{target} along the path. The parameter speed_limit may be determined based on map data defining the speed limits of the road. The weight w_{speed} is configurable to control the contribution of this term to the overall objective function.

$${f}_{static \_ v} = \frac{{w}_{static}}{N} \cdot {\sum }_{{N}_{static}} {\sum }_{N} {e}^{1 - ( A {\tilde{x}}^{2} + B \tilde{x} \tilde{y} + c {\tilde{y}}^{2} )} ,$$

where \tilde{x}=x_{ego}(t)−x_{vehicle}(t) and \tilde{y}=y_{ego}(t)−y_{vehicle}(t), and A, B and C are parameters describing an agent's ellipse. This term encourages the ego vehicle to avoid any static vehicles of the scene, where N_{static} is the number of static agents present. The weight W_{static_v} is configurable to control the contribution of this term to the overall objective function. Collision avoidance is also included as a hard constraint.

$${f}_{dyn \_ v} = \frac{{w}_{dyn}}{N} \cdot {\sum }_{{N}_{dyn}} {\sum }_{N} {e}^{1 - ( A {\tilde{x}}^{2} + B \tilde{x} \tilde{y} + c {\tilde{y}}^{2} )} ,$$

where \tilde{x}=x_{ego}(t)−x_{vehicle}(t) and \tilde{y}=y_{ego}(t)−y_{vehicle}(t), and A, B and C are parameters describing an agent's ellipse. This term encourages the ego vehicle to avoid any static vehicles of the scene, where N_{static} is the number of static agents present. The weight w_{static_v} is configurable to control the contribution of this term to the overall objective function.

$${f}_{occlusion \_ v} = \frac{{w}_{occlusion}}{N} \cdot {\sum }_{{N}_{occlusion}} {\sum }_{N} {e}^{1 - ( A {\tilde{x}}^{2} + B \tilde{x} \tilde{y} + c {\tilde{y}}^{2} )} ,$$

where \tilde{x}=x_{ego}(t)−x_{vehicle}(t) and \tilde{y}=y_{ego}(t)−y_{vehicle}(t), and A, B and C are parameters describing an agent's ellipse. Like the static and dynamic terms above, this term encourages the ego vehicle to avoid occlusions. In this case, the parameters A, B and C are parameters of an occlusion ellipse defining an occluded region of the driveable area to be avoided by the ego vehicle.

$${f}_{border} = \frac{{k}_{b}}{N} \cdot {\sum }_{N} \frac{1}{{( y ( t ) ∓ \frac{{d}_{ego}^{width}}{2} \pm ϵ - b ( x ( t ) ) )}^{2}} ,$$

where b(x(t)) is the piecewise-linear function for the road layout, and the left/right order is considered in evaluating the signs in the denominator. This discourages the ego vehicle from being close to the lane borders. Left and right borders are considered by evaluating the signs in the denominator. The parameter k_{b} is configurable to control the contribution of this term to the overall objective function.

Hard constraints are implemented as inequality and equality constraints, and encode requirements on the planned trajectory. Hard constraints include kinematic constraints, encoding kinematic requirements based on physical laws of motion, speed limit constraints, based on road rules, constraints on the control parameters (acceleration and steering angle), constraints on turn radius and jerk (rate of change of acceleration), constraints enforcing driving within the road border, and constraints preventing vehicle collision. A mathematical definition for each of these example constraints is given below.

Kinematic constraints are implemented by a discrete kinematic bicycle model as the vehicle model, based on the centre of the vehicle. The ego vehicle is modelled as a rectangle with inter-axle distance L. The kinematic constraints are defined as follows:

$$[ {x}_{i + 1} {y}_{i + 1} {θ}_{i + 1} {v}_{i + 1} ] = [ {x}_{i} {y}_{i} {θ}_{i} {v}_{i} ] + [ {v}_{i} cos ( {θ}_{i} + {β}_{i} ) {v}_{i} sin ( {θ}_{i} + {β}_{i} ) \frac{2 {v}_{i}}{L} sin ( {β}_{i} ) {a}_{i} ] \cdot Δ t$$

The speed limit vₘₐₓ, which may be based on a speed limit of the driving lane of the ego vehicle, for example as determined from map data. This is enforced by the inequalities:

vᵢ≤vₘₐₓ

−vᵢ≤0

which ensure that the speed is positive, and that it is less than the determined maximum speed (described above as part of the soft constraint on speed).

Bounds are also applied to the acceleration αᵢ and steering angle βᵢ at each timestep. These are enforced by the below inequalities:

αᵢ−αₘₐₓ≤0,

αₘᵢₙ−αᵢ≤0,

βᵢ−βₘₐₓ≤0,

βₘᵢₙ−βᵢ≤0,

where αₘₐₓ, βₘₐₓ are the upper bounds on acceleration and steering, respectively, and where αₘᵢₙ, βₘᵢₙ are the lower bounds on acceleration and steering, respectively.

A minimum turn radius Rₘᵢₙ is used to constrain the turn radius of the ego vehicle, using the inverse radius 1/R, which crosses zero continuously as the ego vehicle transitions from a left turn to a right turn:

$$- \frac{1}{{R}_{min}} < \frac{{θ}_{i + 1} - {θ}_{i}}{{v}_{i}} < \frac{1}{{R}_{min}} .$$

For vᵢ→0, the turn radius is clamped to zero to avoid turning in place.

Limits on jerk are implemented as follows:

(αᵢ−αᵢ₊₁)²−(δₘₐₓ·Δt)²≤0,

(βᵢ−βᵢ₊₁)²−(γₘₐₓ·Δt)²≤0.

where δₘₐₓ is the maximum acceleration jerk (i.e. the maximum rate of change of acceleration), and γₘₐₓ is the maximum steering jerk, i.e. the maximum rate of change of steering angle.

Border limits ensure that the ego vehicle trajectory remains within left and right borders of the road layout:

$${y}_{border}^{l} ( {x}_{i} ) - {y}_{i} \leq 0 ,$$

$${y}_{i} - {y}_{border}^{r} ( {x}_{i} ) \leq 0 ,$$

where

$${y}_{border}^{l / r}$$

are piecewise linear functions defining the position of road borders, depending on the x-coordinate which defines the distance along the road.

Collision can be detected between the ego vehicle and another agent using an approximate Minkowski difference. If a point exists in both the ego ellipse and the ellipse of the other agent, then the point (0,0) should exist in their Minkowski difference. Representing this difference analytically provides a single collision constraint per agent. The collision avoidance constraint requires that the centre of ego satisfies 1−(A\hat{x}²+B\hat{x}ŷ+Cŷ²)<0, where A, B and C are the parameters of an ellipse determined given the position of the centres of agents from predictions. These equations are derived by rotating the agent's ellipse to make ego axis-aligned, squashing the x-axis by W/L to make the ego's ellipse a circle of diameter W, then inflating the other vehicle's ellipse by W/2 to render ego into a point, with a conservative factor set by default to be ϵ=0.1.

$${\tilde{x}}^{i} = {c}_{x \_ ego}^{i} ( t ) - {x}_{vehicle} ,$$

$${\tilde{y}}^{i} = {c}_{y \_ ego}^{i} ( t ) - {y}_{vehicle} ,$$

$${\tilde{θ}}^{i} = {θ}_{vehicle} - {c}_{θ\_ ego}^{i} ( t ) ,$$

$$λ = \frac{W}{L} ,$$

$${\hat{x}}^{i} = λ \sqrt{{\tilde{x}}^{i 2} + {\tilde{y}}^{i 2}} cos ( arctan ( \frac{{\tilde{y}}^{i}}{{\tilde{x}}^{i}} ) - θ ) , ,$$

$${\hat{y}}^{i} = \sqrt{{\tilde{x}}^{i 2} + {\tilde{y}}^{i 2}} sin ( arctan ( \frac{{\tilde{y}}^{i}}{{\tilde{x}}^{i}} ) - θ ) ,$$

$${a}^{′} = a \sqrt{{λ}^{2} {\tilde{θ}}^{i} + {\tilde{θ}}^{i}} + \frac{( 1 + ϵ ) W}{2} ,$$

$${b}^{′} = b \sqrt{{λ}^{2} {\tilde{θ}}^{i} + {\tilde{θ}}^{i}} + \frac{( 1 + ϵ ) W}{2} ,$$

$${θ}^{′} = arctan ( \frac{tan ( {\tilde{θ}}^{i} )}{λ} ) .$$

As described above, one soft constraint is an occlusion soft constraint, where occlusions are handled by positioning an ellipse, similar to ellipses used to represent vehicles, in front of occluding objects such as parked vehicles, to represent the region that is occluded from the point of view of the ego vehicle. Since occlusions are treated as a soft constraint, this means that in hypothetical scenarios where there is a large number of vehicles, the plan could include incursions into these occluded regions. The size of such ellipses is computed by assuming a particular field of view of the ego vehicle (for example 45° in either direction from the ego vehicle's heading, and checking if any of the corners of the forward vehicle or other occluding object is within that field of view. If so, this means that there is a region beyond that corner that is occluded. The size of the ellipse is then determined by the intersection of two lines: the line whose slope is given by the EV's pose and the relevant occluded corner, and a forward line starting from the centre of the parked vehicle. Different occluded ellipses are generated depending on the offset of the ego vehicle to parked vehicles, as well as their relative orientations.

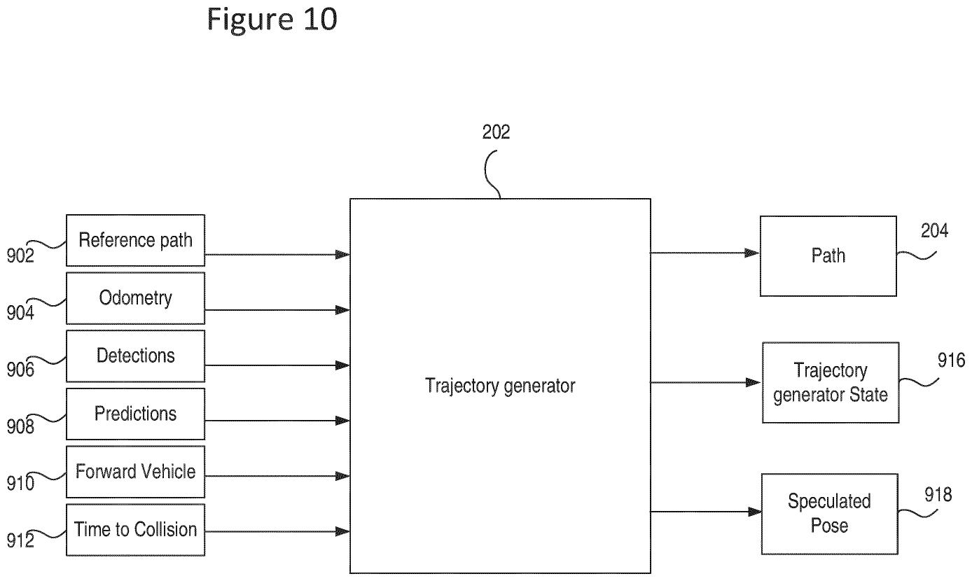

FIG. 10 is a schematic block diagram showing the inputs and outputs of the trajectory generator 202, which comprises a context detector 212, a path generator 214, and a speculation module 216, described above. It should be noted that the path generator 214 generates both a path 204 and a motion profile 206, but that the motion profile is not used as part of the planned trajectory of the vehicle.

The inputs to the trajectory generator 202 include the reference path (default driveable path) 902, odometry data 904, detections 906, predictions 908, forward vehicle properties 910 and time to collision 912.

The reference path 902 is an initialisation path provided to the trajectory generator 202, as described above, by a predefined driveable path generation method, which could include a geometry-based heuristic path generator, or alternatively a trained neural network configured to generate an initialisation path for a given set of scenario inputs.

The odometry data 904 comprises the state of the ego vehicle, including its pose and kinematic properties, such as velocity, acceleration and jerk, and is determined by a separate odometry component. The odometry component is not shown in FIG. 1 but is implemented in addition to the perception stack 102 to measure the ego vehicle's state.

The detections 906 are received from the perception stack 102, describing other dynamic agents present in the driving scenario, including their estimated poses, velocities and accelerations, and covariances representing the perception stack's uncertainty for each of these variables.

The predictions 908 are provided for the agents of the scene by the prediction module 104.

If a forward vehicle 910 exists, its pose, headway and kinematic properties are provided to the trajectory generator by the planner 106.

Time to collision 912 is determined by a time to collision module within the planner 106 as the time before collision with the forward vehicle based on the respective states of the ego vehicle and the forward vehicle.

The outputs of the trajectory generator 202 are the spatial path 204, which is determined by the path generator 214 using constrained optimisation as described above, a trajectory generator state 916, which is determined based on the context detector 212 described above, and a speculated pose 918, determined by the speculation module 216 and used by the path generator 214 to generate the path. The trajectory generator state can be set to any of three states: inactive, beginning, and active. An inactive state means that the trajectory generator is disengaged. A ‘beginning’ state means that the trajectory generator 202 is engaged but that it has yet to produce a path 204. An ‘active’ state means that the trajectory generator 202 is active and generating paths 204 to be consumed by the motion planner 208.

Planning is initialised as follows. The context detector 212, path generator 214 and speculation module 216 are configured according to the planning problem and desired behaviour of the ego vehicle. Since the path generator 214 depends on the map, this can only be initialised when a valid map has been received. The state of the trajectory generator 916 is initialised as inactive.

The context evaluation is then performed as follows. If a time to collision is received, the time to collision value is updated. Otherwise, it is set to a default value. A check is performed to determine if the trajectory generator 202 is engaged. If so, the disengagement conditions are checked according to FIG. 5. If not, the engagement conditions are checked according to FIG. 4. The state 916 of the trajectory generator 202 is updated accordingly.

If the disengagement conditions apply, the trajectory generator 202 is disengaged and an empty path is provided to the motion planner 208, indicating that the trajectory generator is disengaged. If the engagement conditions apply, the ego vehicle's speculated state is set by the speculation module 216, and a plan 204 is generated from that speculated state.

If the plan is generated, and the state 916 is ‘beginning’, a check is performed that the generated path overtakes the forward vehicle. If so, that path is provided to the motion planner 208. If the state 916 is ‘active’, the path is provided to the motion planner 208, and set as the path along which speculation is performed, as described above.

In alternative modes of operation, the trajectory generator 202 is configured to always be engaged. In this case, no checks on engagement/disengagement are performed, and a plan is generated at every planning iteration.

References herein to components, functions, modules and the like, including the trajectory generator 202, motion planner 208, context detector 212, path generator 214, and speculation module 216, denote functional components of a computer system which may be implemented at the hardware level in various ways. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). A computer system may be implemented “onboard” a mobile robot (such as an AV) or “offboard” for example in a simulator context.

1. A computer system for planning a spatial path and a motion profile for an ego agent, the system comprising:
computer-readable storage embodying computer-readable instructions; and
one or more hardware processors coupled to the computer-readable storage and configured to execute the computer-readable instructions which, upon execution, cause the one or more hardware processors to:
receive a state of the ego agent, and
determine, using a trajectory generator, based on the state of the ego agent, a first trajectory via a constrained optimization of a cost function encoding one or more soft planning constraints, subject to one or more hard planning constraints, wherein the first trajectory comprises a spatial path and a motion component, the spatial path determined via the constrained optimization in dependence on at least one of a hard planning constraint and a soft planning constraint on the motion component; and
compute, using a motion planner, based on the spatial path of the first trajectory, a motion profile for the ego agent satisfying one or more constraints of the motion planner.

2. A computer system according to claim 1, wherein the trajectory generator comprises a context detector configured to determine whether to engage the trajectory generator, wherein the trajectory generator is engaged only if predefined engagement criteria are met.

3. A computer system according to claim 2, wherein the motion planner is configured, when the trajectory generator is not engaged, to compute a motion profile for a default reference path.

4. A computer system according to claim 1, comprising:
combining the spatial path of the first trajectory with at least one previous spatial path to generate a stitched spatial path, and
computing the motion profile along a smooth spatial path, wherein the smooth spatial path is generated via spline-fitting applied to the stitched spatial path.

5. A computer system according to claim 1, wherein the trajectory generator comprises a speculation module configured to determine a speculated future state of the ego agent, wherein the first trajectory is generated from a speculated future state of the ego agent.

6. A computer system according to claim 5, wherein the motion planner is configured to compute the motion profile for the ego agent from an actual state of the ego agent corresponding to the speculated future state of the ego agent.

7. A computer system according to claim 1, wherein the motion planner is a physics-based planner configured to implement one or more behaviours in dependence on either a state of the ego agent and the spatial path or a state of the ego agent, the spatial path and at least one further agent.

8. (canceled)

9. A computer system according to claim 1, wherein the trajectory generator comprises a path generation component configured to perform non-linear programming to optimise the cost function subject to the hard planning constraints.

10. A computer system according to claim 1, when implemented as part of an autonomous vehicle stack, wherein the motion planner is configured to output the motion profile to a controller of the autonomous vehicle.

11. (canceled)

12. A computer-implemented method of planning a trajectory for an ego agent, the trajectory comprising a spatial path and a motion profile, the method comprising:
receiving a state of the ego agent;
computing, based on the state of the ego agent, a first trajectory via a constrained optimisation of a cost function encoding one or more soft planning constraints, subject to one or more hard planning constraints, wherein the first trajectory comprises a spatial path and a motion component, the spatial path determined via the constrained optimisation in dependence on at least one of a hard planning constraint and a soft planning constraint on the motion component; and
computing, based on the spatial path, a motion profile for the ego agent, satisfying one or more motion constraints.

13. The method of claim 12, comprising receiving a state of at least one further agent; wherein the first trajectory is computed based on the state of the ego agent and the state of the at least one further agent.

14. The method of claim 13, wherein the at least one further agent comprises a forward agent, positioned ahead of the ego agent, wherein the spatial path is an overtake path.

15. The method of claim 13, wherein the state of the ego agent comprises:
an ego pose comprising a position and orientation of the ego agent; and
one or more ego motion variables defining kinematic properties of the ego agent.

16. (canceled)

17. The method of claim 15, wherein the spatial path comprises a sequence of ego poses corresponding to the ego pose at each timestep of a sequence of N timesteps, and wherein the motion profile comprises a sequence of motion variables corresponding to the ego motion variables at each timestep.

18. The method of claim 12, wherein an initialisation path is generated based on a geometry-based heuristic applied to a road layout, or wherein the initialisation path is generated by a trained neural network.

19. (canceled)

20. (canceled)

21. The method of claim 12, wherein the cost function encodes at least one secondary objective relating to safety and/or comfort.

22. The method of claim 12, wherein the planning constraints comprise kinematic constraints and/or collision avoidance constraints.

23. (canceled)

24. The method of claim 12, comprising outputting one or more control variables corresponding to the spatial path and motion profile to a controller of the ego agent to implement the spatial path and motion profile.

25. The method of claim 13, wherein the motion constraints comprise at least a constraint on a time headway gap between the ego agent at the at least one further agent.

26. A non-transitory medium embodying machine-readable instructions, which, when executed by one or more computer processors, cause the processors to perform planning a trajectory for an ego agent, the trajectory comprising a spatial path and a motion profile, the planning including:
receiving a state of the ego agent;
computing, based on the state of the ego agent, a first trajectory via a constrained optimisation of a cost function encoding one or more soft planning constraints, subject to one or more hard planning constraints, wherein the first trajectory comprises a spatial path and a motion component, the spatial path determined via the constrained optimisation in dependence on at least one of a hard planning constraint and a soft planning constraint on the motion component; and
computing, based on the spatial path, a motion profile for the ego agent, satisfying one or more motion constraints.
